(19) United States
(12) Patent Application Publication
(10) Pub. No.: US 2026/0313398 A1
(43) Pub. Date: Oct. 8, 2026

(54) METHOD AND APPARATUS FOR SUPPORTING SELF-CONFIGURATION AND SELF-OPTIMIZATION

(71) Applicant: SAMSUNG ELECTRONICS CO., LTD., Suwon-si, Gyeonggi-do (KR)

(72) Inventors: Lixiang XU, Beijing (CN); Weiwei WANG, Beijing (CN)

(21) Appl. No.: 18/998,558

(22) PCT Filed: Jul. 27, 2023
(86) PCT No.: PCT/KR2023/010932

§ 371 Date: Jan. 27, 2025

(30) Foreign Application Priority Data
Jul. 28, 2022 (CN) 202210901827.4
Oct. 10, 2022 (CN) 202211236864.4

(51) Int. Cl. H04W 24/04

(52) U.S. Cl. CPC H04W 24/04

(57) ABSTRACT

The disclosure relates to a 5G or 6G communication system for supporting a higher data transmission rate. The disclosure provides a method and an apparatus for supporting self-configuration and self-optimization. The method performed by a first network node of a communication system, includes receiving information related to a Secondary Cell Group (SCG) failure from a User Equipment (UE); transmitting a first failure report information to a second network node.

### TECHNICAL FIELD

The present disclosure relates to generally to wireless communication technology, and more specifically, the present disclosure relates to a method and apparatus for supporting self-configuration and self-optimization.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The present invention has been made to address at least the above problems and/or disadvantages and to provide at least the advantages described below. Accordingly, an aspect of the present invention provides a method and apparatus for supporting self-configuration and self-optimization.

### Solution to Problem

For an enhanced mobility scheme, how to support mobility robustness in the procedure of a dual connectivity is a problem that needs to be solved at present.

According to an aspect of the present disclosure, there is provided a method performed by a first network node of a communication system, the method may include receiving information related to Secondary Cell Group (SCG) failure from a User Equipment (UE); transmitting first failure report information to a second network node.

According to an embodiment of the present disclosure, the method may further comprise receiving second failure report information from the second network node, and transmitting third failure report information to a third network node based on the second failure message.

According to an embodiment of the present disclosure, the information related to the SCG failure includes a Radio Resource Control (RRC) container, which refers to a RRC format of a Radio Access Technology (RAT) supported by a Primary SCG Cell (PSCell), or refers to the RRC format of the RAT supported by the second network node or the third network node.

According to an embodiment of the present disclosure, the RRC container may contain SCG failure information SCGFailureInformation.

According to an embodiment of the present disclosure, the first failure report information or the third failure report information includes at least a part of the information related to the SCG failure.

According to an embodiment of the present disclosure, the first failure report information or the third failure report information includes the RRC container.

According to an embodiment of the present disclosure, the first failure report information or the third failure report information may include at least one of the following information: a cell identity of a source Primary SCG Cell (PSCell), a cell identity of a target PSCell, a cell identity of a suitable PSCell, Secondary Cell Group (SCG) failure information received from the UE, a list of candidate PSCells recommended by a source Master Node (MN) or a source Secondary Node (SN), Conditional PSCell Change (CPC) execution condition(s), a list of candidate PSCells selected by a target SN or a candidate target SN, an estimated arrival probability, a type of the failure, a cell identity of a failed PSCell, a time duration from receiving a RRC reconfiguration message for a PSCell change to the failure, information related to a random access, a measurement result of the UE, location information of the UE, a list of CPC candidate cells, and CPC execution condition(s).

According to an embodiment of the present disclosure, it may further comprise: determining which network node leads to the failure based on the information related to the SCG failure.

According to an embodiment of the present disclosure, it may further include determining a type of the failure based on the information related to the SCG failure.

According to an embodiment of the present disclosure, the first failure report information or the third failure report information is transmitted through an inter-base station interface message.

The inter-base station interface message may be an inter-base station RRC message, an inter-node RRC message, an Xn or X2 message of an inter-base station interface, other inter-base station interface messages, or other network interface messages.

According to an embodiment of the present disclosure, the second failure report information may include at least one of the following information: a Master Node UE Access Protocol Identity (MN UE AP ID); a Secondary Node UE Access Protocol Identity (SN UE AP ID); a list of candidate Primary SCG Cells (PSCells) recommended by a source secondary node; a list of candidate PSCells selected by a target secondary node or a candidate target secondary node; a cell identity of a suitable PSCell; information related to the SCG failure; a cell identity of a source PSCell; a cell identity of a target PSCell; a cell identity of a suitable PSCell which is not selected by the target network node or the candidate target network node; and indication information that the selected candidate PSCell is not suitable.

According to an embodiment of the present disclosure, in case that there is recent PSCell change, the PSCell is the source PSCell of the recent PSCell change, or in case there is no recent PSCell change, the PSCell is a PSCell serving the UE when the SCG failure occurs.

According to the embodiment of the present disclosure, the information related to the SCG failure received from the UE may include at least one of the following information: indication information that whether the CPC has been executed; a time from the CPC execution to the failure; a cell identity of a failed PSCell; a cell identity of a source PSCell of the latest PSCell change; a cell list of CPC candidate PSCells; CPC execution condition(s); a time from the UE receiving a RRC reconfiguration message of the PSCell change from to the failure; a time from the UE receiving CPC configuration to the failure; a time from the UE receiving the CPC configuration to the CPC execution; when a CPC execution condition is fulfilled for execution, indication information corresponding to the CPC execution condition being fulfilled for execution; information that which CPC execution condition is fulfilled first; a time duration between two CPC execution conditions being fulfilled; indication information on the CPC or CPA; a type of the failure; measurement result of the UE; location information of the UE; and information related to a random access.

According to another aspect of the present disclosure, there is provided a first network node in a communication system, the first network node may include a transceiver configured to transmit and receive signals; and a controller coupled to the transceiver and configured to perform operations in the methods as described in the embodiments of the present disclosure.

The robustness of the Primary SCG Cell (PSCell) change in the mobility procedure can be supported by the method. Furthermore, through the method, the robustness of the PSCell change between the different RATs can be supported. Thus, a cause of failure can be correctly identified, so as to make reasonable optimization, reduce occurrence of failure, ensure service continuity, and reduce labor cost of operators.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### Advantageous Effects of Invention

Advantages, and salient features of the invention will become apparent to those skilled in the art from the following detailed description, which, taken in conjunction with the annexed drawings, discloses exemplary embodiments of the invention. For more enhanced communication system, there is a need for a method and apparatus for supporting self-configuration and self-optimization.

### BRIEF DESCRIPTION OF DRAWINGS

FIG. 1 is a system architecture diagram of System Architecture Evolution (SAE);

FIG. 2 is a schematic diagram illustrating an initial overall architecture of 5G;

FIG. 3 is a flowchart of a first method according to an embodiment of the present disclosure;

FIG. 4 is a schematic diagram of an embodiment of the first method according to an embodiment of the present disclosure;

FIG. 5 is a schematic diagram of another embodiment of the first method according to an embodiment of the present disclosure;

FIG. 6 is a flowchart diagram of an embodiment of a second method according to an embodiment of the present disclosure;

FIG. 7 is a schematic diagram of an embodiment of the second method according to an embodiment of the present disclosure;

FIG. 8 is a schematic diagram of another embodiment of the second method according to an embodiment of the present disclosure;

FIG. 9 is a block diagram of a network node according to an embodiment of the present disclosure.

### MODE FOR THE INVENTION

In order to make the purpose, technical schemes and advantages of the embodiments of the disclosure clearer, the technical schemes of the embodiments of the disclosure will be described clearly and completely with reference to the drawings of the embodiments of the disclosure. Apparently, the described embodiments are a part of the embodiments of the disclosure, but not all embodiments. Based on the described embodiments of the disclosure, all other embodiments obtained by those of ordinary skill in the art without creative labor belong to the protection scope of the disclosure.

Before undertaking the DETAILED DESCRIPTION below, it can be advantageous to set forth definitions of certain terms and phrases used throughout the present patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in an appropriate computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the present disclosure. For example, unless otherwise defined, the technical terms or scientific terms used in the disclosure shall have the ordinary meaning understood by those with ordinary skills in the art to which the present disclosure belongs.

It should be understood that “first”, “second” and similar terms used in the disclosure do not express any order, quantity or importance, but are only used to distinguish different components. Similar terms such as singular forms “a”, “an” or “the” do not express a limitation of quantity, but express the existence of at least one of the referenced item, unless the context clearly dictates otherwise.

As used herein, any reference to “an example” or “example”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

It will be further understood that similar terms such as “include” or “comprise” mean that elements or objects appearing before the term encompass the listed elements or objects appearing after the term and their equivalents, but other elements or objects are not excluded. Similar terms such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the present application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the present application can be applied to future-oriented communication technologies. In addition, the technical schemes of the embodiments of the present application can be applied to future-oriented communication technologies.

The following description with reference to the accompanying drawings is provided to assist in a comprehensive understanding of various embodiments of the present disclosure as defined by the claims and their equivalents. The following description includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and phrases used in the following description and claims are not limited to the bibliographical meanings, but, are merely used by the inventor(s) to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed functions, operations or components which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude a possibility of the existence of one or more other characteristics, numbers, steps, operations, constituent elements, components or combinations thereof.

The term “or” used in various embodiments of the present disclosure includes any or all of combinations of listed items. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

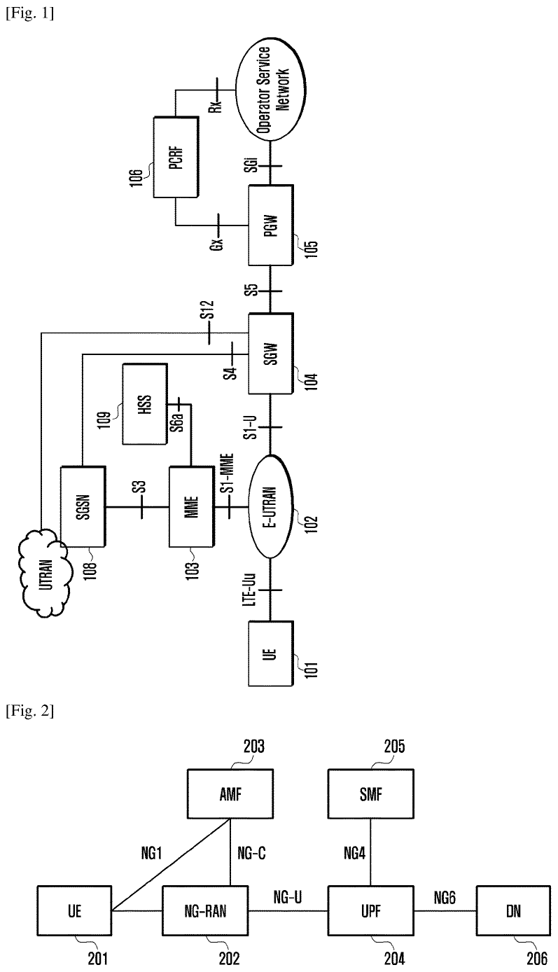

FIGS. 1 to 9 discussed below and various embodiments for describing the principles of the present disclosure in the present patent document are only for illustration and should not be interpreted as limiting the scope of the disclosure in any way. Those skilled in the art will understand that the principles of the present disclosure can be implemented in any suitably arranged system or device.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QOS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current position of the user equipment, an address of a serving node, user security information, and packet data context of the user equipment, etc.

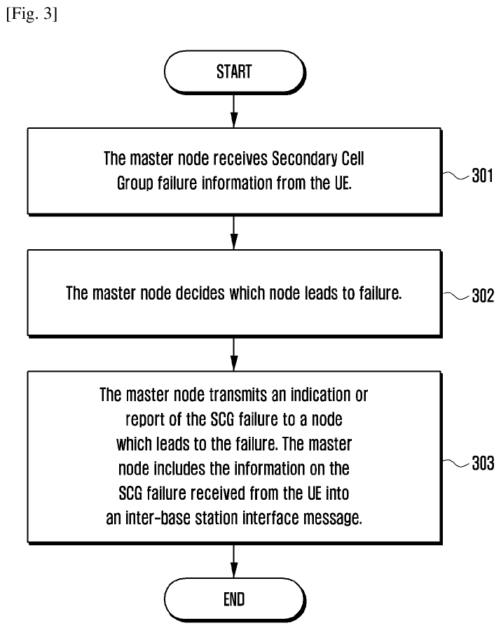

FIG. 2 is an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also referred to as ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

Exemplary embodiments of the present disclosure are further described below with reference to the accompanying drawings.

The text and drawings are provided as examples only to help understand the present disclosure. They should not be interpreted as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure.

In the embodiments according to the present disclosure, Secondary Cell Group (SCG) Failure Information Report contains contents of SCGFailureInformation received from a UE. An MN (Master Node) copies one or more or all of Information Elements in SCGFailureInformation received from the UE into SCG Failure Information Report. The MN decides whether to forward the SCGFailureInformation to the Secondary Node (SN) which causes the failure or to copy information in the SCGFailureInformation into the SCG Failure Information Report message, according to whether different Radio Access Technologies (RATs) are supported by the SN which causes the failure and the Master Node (MN). In the prior art, the MN includes the SCGFailureInformation as a container into an inter-base station interface message transmitted to the SN, and this container is an Information Element (IE) in the inter-base station interface message. In the present method, if the SN which causes the failure and the MN support different RATs, the MN includes one or more or all of information elements in the SCGFailureinformation into the SCG Failure Information Report, and the SCGFailureInformation container may not be included or may be included at the same time. In this way, the SN which causes the issue can obtain the information related to SCG failure transmitted by the UE without parsing the RRC container encoded in the RRC format of the MN. The SCGFailureInformation here can be SCGFailureInformation, SCGFailureInformationEUTRA, or SCGFailureInformationNR. When both the MN and the SN where the failure occurs support the NR radio access technology, the UE transmits the SCGFailureInformation in the NR RRC to the MN; When MN supports the NR radio access technology and the SN where the failure occurs supports the E-UTRA radio access technology, the UE transmits SCGFailureInformationEUTRA to the MN; When both the MN and the SN where the failure occurs support the E-UTRA radio access technology, the UE transmits the SCGFailureInformation in the E-UTRA RRC to the MN; When the MN supports the E-UTRA radio access technology, and the SN where the failure occurs supports the NR radio access technology, the UE transmits SCGFailureInformationNR to the MN.

In an embodiment according to the present disclosure, the SCGFailureinformation or SCGFailureinformationEUTRA of the RRC of the first radio access technology contains the SCGFailureInformation in the RRC format of the second radio access technology. In an embodiment according to the present disclosure, the SCGFailureinformation or SCGFailureinformationEUTRA in NR RRC contains the SCGFailureInformation in the LTE RRC format. The SCGFailureInformation in the LTE RRC format is a container in the NR RRC message. In an embodiment according to the present disclosure, the SCGFailureinformation or the SCGFailureinformationNR in the LTE RRC contains the SCGFailureInformation in the NR RRC format. The UE includes SCGFailueInformation in the source PSCell RRC format (i.e., a container) into the SCGFailueInformation or the SCGFailueInformationEUTRA or the SCGFailueInformationNR in the MN RRC, according to whether there is a recent Primary SCG Cell (PSCell, SpCell (a primary cell of a master or secondary cell group) of a secondary cell group) change and the source PSCell and the MN supporting different RATs. The SCGFailureInformation in the PSCell RRC format is a container, the container referring to the Radio Resource Control (RRC) format of the Radio Access Technology (RAT) supported by the PSCell. The UE can also include the SCGFailueInformation in the target PSCell RRC format into the SCGFailueInformation or the SCGFailueInformationEUTRA or the SCGFailueInformationNR in the MN RRC, according to whether there is a recent PSCell change and the target PSCell and the MN supporting different RATs.

Exemplary embodiments of the present disclosure are further described below with reference to the accompanying drawings.

The text and drawings are provided as examples only to help understand the present disclosure. They should not be interpreted as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure.

It should be noted that the approach proposed in the present disclosure is applicable to the PSCell change procedure, including a normal PSCell Change procedure and a Conditional PSCell Change (CPC) procedure or a Conditional PSCell Addition (CPA) procedure. For the CPC and CPA procedure, although the CPC is taken as an example in the present disclosure, the problems and methods described in the present disclosure are also applicable to the CPA procedure. When applying to the CPA, it is only necessary to replace the CPC with the CPA. Similarly, the methods described in the present disclosure are also applicable to a Conditional PSCell Addition or Change (CPAC) procedure, and the CPC is replaced by the CPAC when applying.

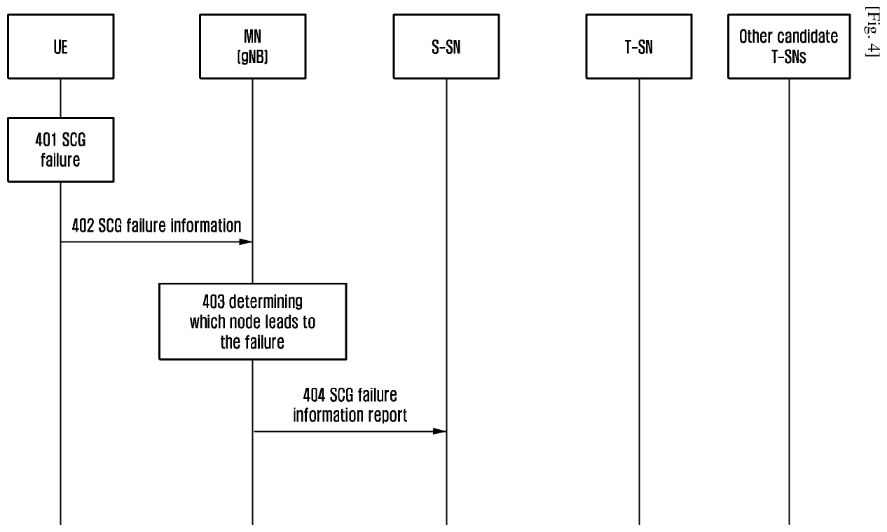

FIG. 3 illustrates an example of a first method for supporting self-configuration and self-optimization according to the present disclosure. The method is described from a perspective of a master base station. The method comprises the following steps:

At step 301, a master node receives information on Secondary Cell Group (SCG) failure from a UE. The information on the SCG failure may be SCGFailureInformation or SCGFailureInformationEUTRA in TS38.331, or SCGFailureInformation or SCGFailureInformationNR in TS36.331, or it may be the information on the SCG failure received through other messages.

The information on the SCG failure includes one or more of the following information elements:
Indication information whether a CPC has been executed;
A time from CPC execution to a failure;
A cell identity of a failed PSCell. The cell identity may be information on a global cell identity, or a physical cell identity and a frequency. The global cell identity may further include Tracking Area Code (TAC) or a tracking area identity of the cell;
A cell identity of a source PSCell of the latest PSCell change. The cell identity may be information on a global cell identity, or a physical cell identity and a frequency. The global cell identity can also include the Tracking Area Code (TAC) or the tracking area identity of the cell;
A cell list of CPC candidate PSCells. A list of candidate CPC cells may be included directly, or indication information that a cell is CPC candidate cell is included for the cells in a measurement result which are the CPC candidate cell, additionally, information on one or more cells which are the CPC candidate cells but not in the measurement result is comprised in the secondary cell group failure information. Each of the candidate PSCells contains a cell identity, which may be a global cell identity. The cell identity may further include Tracking Area Code (TAC);
CPC execution condition(s). The CPC execution condition(s) can be one or more. There are one or more execution conditions for each of candidate PSCell cells;
A Time from a UE receiving a RRC reconfiguration message for the PSCell change to a failure;
A Time from a UE receiving CPC configuration to a failure;
A Time from a UE receiving the CPC configuration to CPC execution;
Indication information corresponding to a CPC execution condition being fulfilled for execution when the CPC execution condition is fulfilled for execution;
Information which CPC execution condition is fulfilled first;
A time duration between two CPC execution conditions being fulfilled;
Indication information on a CPC or a CPA;
A type of failure;
Measurement result of a UE;
Location information of a UE;
Information related to a Random Access (RA).

The above failure is a SCG failure.

At step 302, the master node decides which node leads to the failure. For example, it is the Master Node (MN), the Source Secondary Node (S-SN), the Target Secondary Node (T-SN) or other candidate secondary node. The master node may transmit the SCG failure information to the secondary node where the failure occurs, and the secondary node, where the failure occurs, determines whether the failure is caused by itself.

The master node decides which node leads to the failure according to information in the SCG failure information received from the UE and/or information stored by the MN.

The master node can also determine a type of failure occurring, such as a too early PSCell change, a too late PSCell change or trigger of a PSCell change to a wrong PSCell cell.

If a SCG failure occurs after a UE has stayed in a PSCell for a long time, for example, if the UE does not report the time from an RRC reconfiguration message including SCG reconfiguration with synchronization to the SCG failure occurrence or the time is greater than a configured threshold, and there is a suitable PSCell different from the PSCell where the UE is located at the time that the failure occurs, then it is the too late PSCell change. Alternatively, if the UE does not report the time from the CPC execution to the failure occurrence, or the time from the CPC execution to the failure occurrence reported by the UE is greater than a configured threshold, and there is a suitable PSCell different from the PSCell where the UE is located at the time the failure occurs, then it is the too late CPC execution or the too late PSCell change. The MN knows the suitable PSCell according to a measurement report received from the UE, or the MN knows the suitable PSCell according to the measurement report received from the UE and the information stored by the MN.

Too early PSCell change: there is a recent CPC execution or PSCell change before the failure occurs, for example, according to an indication on CPC execution or according to a time from the CPC execution to the failure occurrence being smaller than a configured threshold or according to the time from the RRC reconfiguration message including SCG reconfiguration with synchronization to the SCG failure occurrence being smaller than a configured threshold, and the source PSCell is a suitable PSCell, thus it is a too early PSCell change. The MN knows the suitable PSCell according to the measurement report received from the UE, or the MN knows the suitable PSCell according to the measurement report received from the UE and the information stored by the MN. The SCG failure can be a failure which occurs shortly after a successful change from a source PSCell to a target PSCell or a failure which occurs during the PSCell change procedure. The source PSCell is a source PSCell of the latest PSCell change.

Trigger of a PSCell change to a wrong PSCell: before the failure occurs, there is a recent CPC execution or PSCell change, for example, according to an indication on CPC execution or according to a time from the CPC execution to the failure occurrence being smaller than a configured threshold, or according to the time from the RRC reconfiguration message including SCG reconfiguration with synchronization to the SCG failure occurrence being smaller than a configured threshold, and the suitable PSCell is not the source PSCell or the target PSCell, then it is trigger of the PSCell change to the wrong PSCell. The MN knows the suitable PSCell according to the measurement report received from the UE, or the MN knows the suitable PSCell according to the measurement report received from the UE and the information stored by the MN. The SCG failure can a failure which occurs shortly after a successful change from a source PSCell to a target PSCell or a failure which occurs during the PSCell change procedure. The source PSCell is a source PSCell of the latest PSCell change. The target PSCell is a target PSCell of the latest PSCell change.

For the too late PSCell change, the MN and the source SN serving the UE are the nodes that lead to the failure.

For the too early PSCell change, if the PSCell change is triggered by the MN, then the MN is the node that leads to the failure. If the PSCell change is triggered by the source SN, the source SN is the node that leads to the failure.

For the trigger of the PSCell change to the wrong PSCell, if the PSCell change is triggered by the MN, then the MN is the node that leads to the failure. If the PSCell change is triggered by the source SN, the source SN is the node that leads to the failure.

For the trigger of the PSCell change to the wrong PSCell in the CPC procedure, the MN can further determine whether the failure is caused by the unreasonable configuration of CPC candidate cells or by the unreasonable configuration of CPC execution condition. If the suitable cell is not in the CPC candidate cells configured to the UE, the failure is caused by the unreasonable configuration of CPC candidate cells. If the suitable cell is not in the list of the CPC candidate cells recommended by a source base station (the MN or a source SN) that triggers the PSCell change, the problem is caused by the source base station that triggers the PSCell change. For example, if the PSCell change is triggered by the MN, a problem is caused by the MN, and if the PSCell change is triggered by the source SN, the problem is caused by the source SN. If the suitable cell is in the list of the CPC candidate cells recommended by the source base station (the MN or the source SN) that triggers the PSCell change, but not in the list of the candidate PSCells selected by the target SN or the candidate target SN, the failure is caused by the target SN or the candidate target SN. The MN can also determine whether the failure is caused by an estimated arrival possibility which is set improperly. For example, the estimated arrival probability transmitted to the candidate target SN by the MN or by the source SN through the MN is set too low, while the suitable cell is in the candidate SN, and thus the MN or the source SN is the node that leads to the failure. If the estimated arrival probability is decided by the source SN, then the failure is caused by the source SN.

If the MN is the node which leads to the failure, step 303 does not need to be performed. If the problem is caused by the source SN, the target SN or the candidate target SN, step 303 is performed.

At step 303, the master node transmits the secondary cell group failure indication or report to the secondary node which leads to the failure. For the CPC, the secondary node which leads to the failure can be the source SN, the target SN or the candidate SN. For the CPA, the secondary node which leads to the failure can be the target SN or the candidate SN. For the normal PSCell change, the secondary node which leads to the failure can be the source SN or the SN where the failure occurs.

According to the description in step 302, the MN knows that the failure is caused by the source SN, the target SN or the candidate target SN.

The MN can transmit information on the secondary cell group failure to the secondary node which leads to the failure through the secondary cell group failure information report message or other messages. If the MN and the SN which leads to the failure are nodes supporting different Radio Access Technologies (RATs), the MN includes one or more or all information contained in the SCG failure information received from the UE into the inter-base station interface (such as Xn or X2 interface) message to be transmitted to the SN. In the prior art, the MN directly includes the secondary cell group failure information (such as SCGFailureInformation or SCGFailureInformationEUTRA or SCGFailureNR) received from the UE into the inter-base station interface message to be transmitted to the SN, that is, it is transmitted to the SN in the form of a Radio Resource Control (RRC) container. As a result, a problem occurs that if the SN and the MN support different radio access technologies, the SN may not be able to read the secondary cell group failure information encoded according to the RRC of the MN, so that the SN cannot determine the cause of the SCG failure, and accordingly cannot make corresponding optimization. In the method of the present disclosure, if the SN and the MN support different radio access technologies, the MN puts a part of or all content of the secondary cell group failure information in the RRC message into the inter-base station interface message respectively and transmits the message to the SN. The inter-base station interface message may be an inter-base station RRC message, an inter-node RRC message, an Xn or X2 message of an inter-base station interface, other inter-base station interface messages, or other network interface messages. The MN puts the information in the SCG failure information into the inter-base station interface message and transmits the inter-base station interface message to the SN. The inter-base station interface message may be an inter-base station interface RRC message or an inter-node RRC message, and the MN transmits the inter-base station interface RRC message or the inter-node RRC message to the SN. The MN may include the inter-base station interface RRC message or the inter-node RRC message into the Xn or X2 message and transmit the same to the SN. The inter-base station interface RRC message or inter-node RRC message is encoded according to the RRC format of the radio access technology supported by the SN. The inter-base station interface RRC message or inter-node RRC message may be a newly defined inter-node RRC message or an existing inter-node RRC message, and no limitation is made on the method of the present disclosure. The MN can also respectively put a part of or all contents of the secondary cell group failure information into the Xn or X2 or other network interface messages transmitted to the SN, and what is included into the message is a plurality of IEs in the secondary cell group failure information. In this way, even if the SN does not support the RRC of the radio access technology of the MN, the SN can obtain necessary information from the inter-base station interface message, so as to detect the type of the failure and make corresponding optimization. It is possible for the MN to not include the secondary cell group failure information (such as SCGFailureInformation or SCGFailureInformationEUTRA or SCGFailureNR) received from the UE into the message to be transmitted to the SN, that is, the inter-base station interface message may not include the RRC container, and the MN may also include the secondary cell group failure information container into the inter-base station interface message.

For example, the MN is a gNB supporting the new radio (NR) access technology, the SN is an ng-eNB supporting the evolved Universal Mobile Telecommunications System (UMTS) Terrestrial Radio Access (E-UTRA). When the MN has received the SCGFailureInformationEUTRA in the NR RRC format from UE, in the prior art, the MN includes the SCGFailureInformationEUTRA into the SCG failure information report message to be transmitted to the SN. In the method of the present disclosure, the MN includes one or more or all information elements contained in the SCGFailureInformationEUTRA into the inter-base station interface RRC message or the inter-node RRC message respectively, and transmits the inter-base station interface RRC message or the inter-node RRC message to the SN. The MN transmits the inter-base station interface RRC message or the inter-node RRC message to the SN through the SCG failure information report message. The inter-base station interface RRC message or the inter-node RRC message is encoded according to the RRC format of the radio access technology supported by the SN. If the SN supports the base station of the E-UTRA radio access technology, the inter-base station interface RRC message or the inter-node RRC message is encoded according to the RRC format of the E-UTRA, for example, defined in TS36.331; or the MN includes one or more or all information elements contained in the SCGFailureInformationEUTRA into the SCG failure information report message, respectively. For example, a type of failure, measurement result, location information, a source PSCell identity, a failed PSCell identity, a list of PSCell candidate cells, and/or PSCell execution condition(s) contained in the SCGFailureInformationEUTRA are included into the SCG failure information report message, and the SCGFailureInformationEUTRA container may be or may not be included in SCG failure information report message.

The message transmitted by the master node to the secondary node which caused the problem contains one or more information elements in the secondary cell group failure information received from the UE. For example:
A cell identity of the source PSCell;
A cell identity of the target PSCell;
A cell identity of the suitable PSCell;
SCG failure information received from the UE;
A list of candidate PSCells recommended by the source MN or the source SN. Each of candidate PSCells includes a cell identity, which may be a global cell identity. The global cell identity may further include a tracking area code (TAC);
CPC execution condition(s). There are one or more execution conditions for each of candidate PSCells;
A list of candidate PSCells selected by the target SN or the candidate target SN. Each of candidate PSCells includes a cell identity, which may be a global cell identity. A Tracking Area Code (TAC) can be further included;
An estimated Arrival Probability;
A type of the failure. The type of the failure includes a too early PSCell change, a too late PSCell change or trigger of a PSCell change to a wrong PSCell, an inappropriate configuration for the CPC candidate cell, an inappropriate CPC execution condition, and/or an inappropriate configuration for the estimated arrival probability. The information is included when the type of the failure is determined by the MN, and the information element is not included if the type of failure is determined by the SN which leads to the problem.

If the MN only determines which node leads to the failure, the source SN, the target SN or the candidate SN determines the type of failure, such as, e.g., a too early PSCell change, a too late PSCell change or trigger of a PSCell change to a wrong PSCell, after receiving the message from the MN.

If a SCG failure occurs after a UE has stayed in a PSCell for a long time, for example, if the UE does not report the time from the RRC reconfiguration message including SCG reconfiguration with synchronization to the SCG failure occurrence, or the time is greater than a configured threshold, and there is a suitable PSCell different from the PSCell where the UE is located at the time the failure occurs, then it is the too late PSCell change. Alternatively, if the UE does not report the time from the CPC execution to the failure occurrence, or the time from the CPC execution to the failure occurrence reported by the UE is greater than a configured threshold, and there is a suitable PSCell different from the PSCell where the UE is located at the time the failure occurs, then it is the too late CPC execution or the too late PSCell change. The SN knows the suitable PSCell according to a measurement report received from the UE, or the SN knows the suitable PSCell according to the measurement report received from the UE and the information stored by the SN.

Too early PSCell change: there is a recent CPC execution or PSCell change before the failure occurs, for example, according to an indication on CPC execution or according to a time from the CPC execution to the failure occurrence being smaller than a configured threshold or according to a time from the RRC reconfiguration message including SCG reconfiguration with synchronization to the SCG failure occurrence being smaller than a configured threshold, and the source PSCell is a suitable PSCell, thus it is a too early PSCell change. The SN knows the suitable PSCell according to a measurement report received from the UE, or the SN knows the suitable PSCell according to the measurement report received from the UE and the information stored by the SN. The SCG failure can a failure which occurs shortly after a successful change from a source PSCell to a target PSCell or a failure which occurs during the PSCell change procedure. The source PSCell is a source PSCell of the latest PSCell change.

Trigger of a PSCell change to a wrong PSCell: before the failure occurs, there is a recent CPC execution or PSCell change, for example, according to an indication on CPC execution or according to a time from the CPC execution to the failure occurrence being smaller than a configured threshold or according to a time the RRC reconfiguration message including SCG reconfiguration with synchronization to the SCG failure occurrence being smaller than a configured threshold, and the suitable PSCell is not the source PSCell or the target PSCell, it is trigger of the PSCell change to a wrong PSCell. The SN knows the suitable PSCell according to a measurement report received from the UE, or the SN knows the suitable PSCell according to the measurement report received from the UE and the information stored by the SN. The SCG failure can a failure which occurs shortly after a successful change from a source PSCell to a target PSCell or a failure which occurs during the PSCell change procedure. The source PSCell is a source PSCell of the latest PSCell change. The target PSCell is a target PSCell of the latest PSCell change.

For the CPC procedure, the source SN can further determine whether the failure is caused by the unreasonable configuration of CPC candidate cells or by the unreasonable configuration of CPC execution condition. If the suitable cell is not in the CPC candidate cells configured to the UE, the failure is caused by the unreasonable configuration of CPC candidate cells. If the suitable cell is not in the list of the CPC candidate cells recommended by the source SN that triggers the PSCell change, the problem is caused by the source SN that triggers the PSCell change. If the suitable cell is in the list of the CPC candidate cells recommended by the source SN that triggers the PSCell change, but not in the list of the candidate PSCells selected by the target SN or the candidate target SN, the failure is caused by the target SN or the candidate target SN. For the trigger of the PSCell change to the wrong PSCell, the source SN can further determine whether the failure is caused by the unreasonable configuration of the candidate cell.

For the failure caused by the target SN or the candidate target SN, the present disclosure proposes two approaches for indicating to the target SN or the candidate target SN:

A first approach: the MN determines that the target SN or the candidate target SN leads to a problem, and the specific approach is described in step 302. The MN transmits indication or report information on the SCG failure to the target SN or the candidate target SN. The message includes one or more information elements in the SCG failure information, and the MN directly includes the one or more information elements into the message to be transmitted to the SN instead of including the RRC container into the message to be transmitted to the SN. The message may also contain other information without affecting the main content of the present disclosure.

A second approach: the MN transmits the indication or report information on the SCG failure to the source SN, and the source SN further determines a type of the failure. If the source SN determines that the problem is caused by the target SN or the candidate target SN, the source SN transmits a message to the MN. The message transmitted by the source SN to the MN includes a MN UE Access Protocol (AP) Identity (ID), a SN UE AP ID, a list of candidate PSCells recommended by the source SN, a list of candidate PSCells selected by the target SN or the candidate target SN, a cell identity of a suitable PSCell, a cell identity of a source PSCell, a cell identity of a target PSCell, a cell identity of a suitable PSCell which is not selected by the target SN or the candidate target SN, and/or indication information that the selected candidate PSCell is unsuitable. Each of candidate PSCells contains a cell identity, which may be a global cell identity. A Tracking Area Code (TAC) can be further included. The source SN can transmit the above information to the MN through a SCG failure transfer message or other message. The MN transmits a message to the target SN or the candidate target SN, and the message includes the same information as those described in the first approach, which will not be repeated here.

The source SN can also determine whether the failure is caused by an estimated arrival probability which is set improperly, for example, the estimated arrival probability transmitted by the source SN to the candidate target SN via the MN is set too low, and the suitable cell is in the candidate SNs. In such a case, the source SN is the node that leads to the failure.

The PSCell change or CPC is optimized reasonably by the node (the source SN, the target SN or the candidate target SN, or the MN) which leads to the failure.

As such, the first method for supporting self-configuration and self-optimization proposed in the present disclosure has been described, and the method can support robustness of PSCell change in the mobility procedure, especially the robustness in the PSCell change between the different RATs, and thus correctly identify the causes of failure, so as to make reasonable optimization, reduce occurrence of a failure, ensure service continuity, and reduce labor cost of an operator.

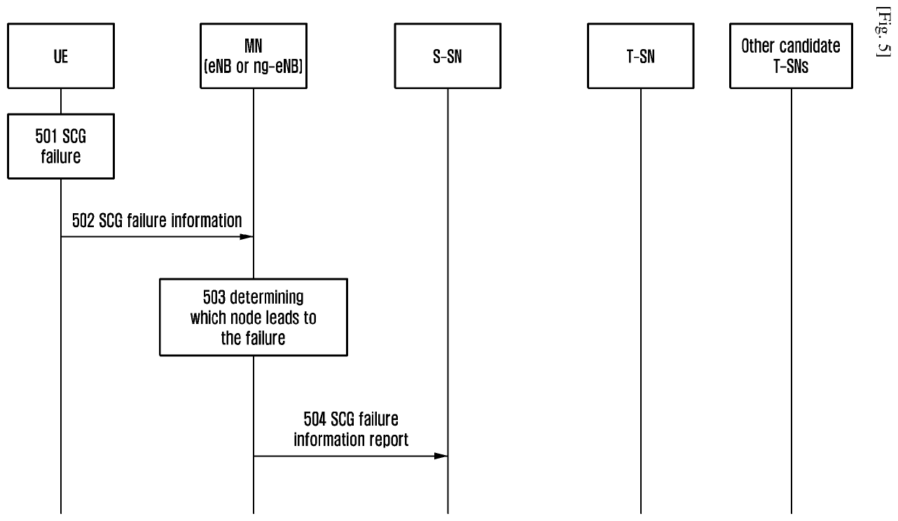

FIG. 4 illustrates a first embodiment of the first method supporting self-configuration and self-optimization according to the present disclosure. In the embodiment, the MN is a gNB, and the source SN is a gNB or an ng-eNB. The method comprises the following steps:

At step 401, a SCG failure occurs. The SCG failure may be a failure when the UE accesses to the target PSCell of the target SN or a failure occurring in the CPC execution to the target PSCell or a failure occurring after a successful PSCell change. The UE stores information related to the failure. The information related to the failure is the information on the secondary cell group failure described at step 301, which will not be repeated here.

At step 402, the UE transmits the SCG failure information to the MN. The SCG failure information may be the SCGFailureInformation or SCGFailureInformationEUTRA. If the PSCell where the failure occurs is an NR cell, the SCG failure information is the SCGFailureInformation. If the PSCell where the failure occurs is an E-UTRA cell, the SCG failure information is the secondary cell group failure information EUTRA (SCGFailureInformationEUTRA). The information included in the SCG failure information is the same as those described at step 301, which will not be repeated here. The UE may transmit the SCG failure information to the MN through the existing SCG failure information message or other RRC messages.

At step 403, the MN determines which node causes the failure. The determining method used by the MN is the same as that at step 302, and will not be described here repeatedly. The MN can further determine a type of the failure, and the specific determining method is the same as that at step 302, which will not be repeated here.

If the failure is caused by the MN, the procedure ends, and the subsequent steps do not need to be performed.

For the problem caused by the source SN, step 404 is performed.

At step 404, the MN transmits SCG failure information report message to the source SN.

If the source SN is a gNB, the MN directly contains the SCG failure information in the SCG failure information report message. If the source SN and the MN support different radio access technologies (such as ng-eNB), the MN puts the information in the SCG failure information into an inter-node message or an inter-node RRC message, and transmits the information in the SCG failure information to the source SN through the inter-node message or the inter-node RRC message; and the MN includes the inter-node message or the inter-node RRC message into the SCG failure information report message, and transmits the inter-node message or the inter-node RRC message to the source SN through the SCG failure information report message. If the source SN and the MN support different radio access technologies (such as ng-eNB), the MN may also include one or more or all of the information contained in the SCG failure information into the SCG failure information report message, respectively. The information contained in the SCG failure information is, for example, a cell identity of the source PSCell, a cell identity of the failed PSCell, a time duration from receiving the RRC reconfiguration message for the PSCell change to the failure, RA information, measurement result of the UE, location information of the UE, a list of CPC candidate cells, and/or CPC execution condition(s), etc.. The MN includes the above information into the SCG failure information report message. The SCG failure information report message may or may not contain the SCG failure information container.

The message may also include the information transmitted by the MN to the source SN in step 303, which will not be repeated here. The message transmitted by the MN to the source SN may be an existing SCG failure information report or other messages. If the type of the failure is determined by the source SN, the determining method used by the source SN is the same as that described at step 303.

So far, the first embodiment of the first method for supporting self-configuration and self-optimization proposed in the present disclosure has been described, which can support robustness of the PSCell change in the mobility procedure, especially the robustness of the PSCell change between the different RATs, and thus correctly identify the causes of the failure, so as to make reasonable optimization, reduce occurrence of a failure, ensure service continuity, and reduce labor cost of an operator.

FIG. 5 illustrates a second embodiment of the first method supporting self-configuration and self-optimization according to the present disclosure. In this embodiment, the MN is an eNB or an ng-eNB, and if the MN is an eNB, then the source SN is a gNB (en-gNB) as the SN in the EN-DC. If the MN is an ng-eNB, then the source SN may be a gNB or an ng-eNB. The method comprises the following steps:

At step 501, a SCG failure occurs. The SCG failure may be a failure when the UE accesses to the target PSCell of the target SN or a failure occurring in the CPC execution to the target PSCell or a failure occurring after the successful PSCell change. The UE stores information related to the failure. The information related to the failure is the information on the secondary cell group failure described at step 301, which will not be repeated here.

At step 502, the UE transmits SCG failure information to the MN. The SCG failure information may be SCGFailureInformation or secondary cell group failure information NR (SCGFailureInformationNR). If the PSCell where the failure occurs is an NR cell, the SCG failure information is SCGFailureInformationNR. If the PSCell where the failure occurs is an E-UTRA cell, the SCG failure information is SCGFailureInformation. The information included in the SCG failure information is the same as that described at step 301, which will not be repeated here. The UE may transmit the SCG failure information to the MN through the existing SCG failure information message or other RRC messages. The information included in the SCG failure information is the same as that described at step 301, which will not be repeated here.

At step 503, the MN determines which node causes the failure. The determining method used by the MN is the same as that described at step 302, and will not be described here. The MN can further determine a type of failure, and the specific determining method is the same as that at step 302, which will not be repeated here.

If the failure is caused by the MN, the procedure ends, and the subsequent steps do not need to be performed.

For the problem caused by the source SN, step 504 is performed.

At step 504, the MN transmits SCG failure information report message to the source SN.

If the source SN is a base station which supports the E-UTRA radio access technology (eNB or ng-eNB), the MN directly includes the SCG failure information into the SCG failure information report message. If the source SN and the MN support different radio access technologies (such as gNB or en-gNB), the MN puts the information in the SCG failure information into an inter-node message or an inter-node RRC message, and transmits the information in the SCG failure information to the source SN through the inter-node message or the inter-node RRC message; and the MN includes the inter-node message or the inter-node RRC message into the SCG failure information report message, and transmits the inter-node message or the inter-node RRC message to the source SN through the SCG failure information report message. If the source SN and the MN support different radio access technologies (such as gNB or en-gNB), the MN may also include one or more or all of the information contained in the SCG failure information into the SCG failure information report message, respectively. The information contained in the SCG failure information is, for example, a cell identity of the source PSCell, a cell identity of the failed PSCell, a time duration from receiving the RRC reconfiguration message for the PSCell change to the failure occurrence, RA information, measurement result of the UE, location information of the UE, a list of the CPC candidate cells, and/or CPC execution condition(s), etc.. The MN includes the above information into the SCG failure information report message. The SCG failure information report message may or may not contain the SCG failure information container.

The message may also include the information transmitted by the MN to the source SN at step 303, which will not be repeated here. The message transmitted by the MN to the source SN may be an existing SCG failure information report or other messages. If the type of the failure is determined by the source SN, the determining method used by the source SN is the same as that described at step 303.

So far, the second embodiment of the first method for supporting self-configuration and self-optimization proposed in the present disclosure has been described, and such method can support robustness of the PSCell change in the mobility procedure, especially the robustness in the PSCell change between the different RATs, and thus correctly identify the causes of the failure, so as to make reasonable optimization, reduce occurrence of a failure, ensure service continuity, and reduce labor cost of an operator.

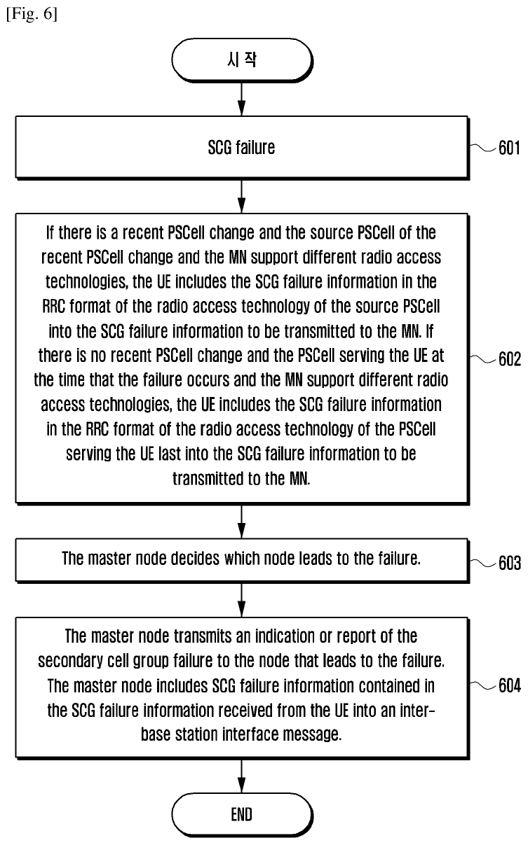

FIG. 6 illustrates an example of a second method supporting self-configuration and self-optimization according to the present disclosure. The method comprises the following steps:

At Step 601, a SCG failure occurs for a UE. The UE stores information on the failure.

At Step 602, if there is a recent PSCell change, and the source PSCell of the recent PSCell change and the MN support different radio access technologies, the UE includes the SCG failure information in the RRC format of the radio access technology of the source PSCell, into the SCG failure information to be transmitted to the MN. If there is no recent PSCell change, the UE includes the SCG failure information (i.e., RRC container) in the RRC format of the radio access technology of the PSCell serving the UE at the time of the failure occurs, into the SCG failure information to be transmitted to the MN. For example, the MN is a gNB, and the SN which controls the PSCell serving the UE is an ng-eNB; there is no recent PSCell change, the SCG failure occurs for the UE, and the UE generates the SCG failure information according to the NR RRC, and herein the SCG failure information is SCGFailureInformationEUTRA. At the same time, the SCG failure information in the LTE RRC is included in the SCG failure information in the NR RRC. For another example, the MN is a gNB, and there is a recent PSCell change; the source SN is an ng-eNB, and the target SN is a gNB; the PSCell change fails or the SCG failure occurs just after a successful PSCell change, the UE generates the SCG failure information according to the NR RRC, and includes the SCG failure information in LTE RRC into the SCG failure information in the NR RRC. The SCG failure information in the NR RRC can be SCGFailureInformation or SCGFailureInformationEUTRA. The UE knows whether there is a recent PSCell change according to the time from configuration of the recent PSCell change to the failure or the time from execution of the recent PSCell change to the failure.

The secondary cell group failure information includes one or more of following information:
Indication information whether a CPC has been executed;
A time from CPC execution to a failure;
A cell identity of a failed PSCell. The cell identity may be information on a global cell identity, or a physical cell identity and a frequency. The global cell identity may further include Tracking Area Code (TAC) or a tracking area identity of the cell;
A cell identity of a source PSCell of the latest PSCell change. The cell identity may be information on a global cell identity, or a physical cell identity and a frequency. The global cell identity can also include the Tracking Area Code (TAC) or the tracking area identity of the cell;
A cell list of CPC candidate PSCells. It may directly include a list of candidate CPC cells, or indication information on the CPC candidate cells for the cells contained in a measurement result which are the CPC candidate cells, or additionally include information on one or more CPC candidate cells which are the CPC candidate cells but not in the measurement result, in a secondary cell group failure information. Each of the candidate PSCells contains a cell identity, which may be a global cell identity. The global cell identity may further include Tracking Area Code (TAC);
CPC execution condition(s). The CPC execution condition(s) can be one or more. There are one or more execution conditions for each of the candidate PSCell cells;
A Time from UE receiving a RRC reconfiguration message for the PSCell change to a failure;
A Time from UE receiving a CPC configuration to a failure;
A Time from UE receiving a CPC configuration from to a CPC execution;
Indication information corresponding to a CPC execution condition being fulfilled when the CPC execution condition is fulfilled;
Information which CPC execution condition is fulfilled first;
A time duration between the two CPC execution conditions being fulfilled;
Indication information on a CPC or a CPA;
A type of a failure;
Measurement result of a UE;
Location information of a UE;
Information related to a Random Access (RA).

The above failure is the SCG failure. Both the NR RRC SCG failure information and LTE RRC SCG failure information include the above information.

At Step 603, the master node decides which node leads to the failure. For example, it is the master node, the source secondary node, the target secondary node or other candidate secondary node.

The master node decides which node leads to the failure according to information in the SCG failure information received from the UE and/or the information stored by the MN.

The master node can also determine a type of a failure occurring, such as a too early PSCell change, a too late PSCell change or trigger of a PSCell change to a wrong PSCell cell. The method used by the master node for determining is the same as that in step 302, and the detail is omitted.

For the too late PSCell change, the MN and the source SN serving the UE are the node that leads to the failure.

For the too early PSCell change, if the PSCell change is triggered by the MN, then the MN is the node that leads to the failure. If the PSCell change is triggered by the source SN, the source SN is the node that leads to the failure.

For the trigger of the PSCell change to the wrong PSCell, if the PSCell change is triggered by the MN, then the MN is the node that leads to the failure. If the PSCell change is triggered by the source SN, the source SN is the node that leads to the failure.

For the trigger of the PSCell change to the wrong PSCell in the CPC procedure, the MN can further determine whether the failure is caused by unreasonable configuration of CPC candidate cells or by unreasonable configuration of CPC execution condition(s). The specific method for determining is the same as that described above, and the detail is omitted.

If the MN is the node which leads to the failure, step 604 does not need to be performed. If the problem is caused by the source SN or the last serving SN for the UE, step 604 is performed.

At Step 604, the master node transmits the secondary cell group failure indication or report to the secondary node that caused the failure.

According to the description at step 603, the MN knows that the failure is caused by the source SN, the last serving SN for the UE, the target SN or the candidate target SN.

The MN can transmit the information on the secondary cell group failure to the secondary node that caused the problem through the secondary cell group failure information report message or other messages. If the MN and the SN which caused the problem are nodes supporting different Radio Access Technologies (RATs), the MN includes SCG failure information contained in the SCG failure information received from the UE, into an inter-base station interface (such as Xn or X2) message to be transmitted to the SN. For example, the MN is a gNB, and the SN which caused the failure is an ng-eNB. The NR RRC SCG failure information received by the MN from the UE includes SCGFailureInformation in the LTE RRC, and the MN transmits the SCGFailureInformation in the LTE RRC to the SN which caused the problem. For another example, the MN is an eNB and the source SN is a gNB; the PSCell change fails or the SCG failure occurs just after a successful PSCell change, and the MN transmits the SCGFailureInformation in the NR RRC contained in the LTE RRC SCG failure information received from the UE to the SN that caused the problem. In the prior art, the MN directly includes the secondary cell group failure information (such as SCGFailureInformation or SCGFailureInformationEUTRA or SCGFailureNR) in the radio access technology RRC supported by the MN received from the UE, into the interface message between base stations to be transmitted to the SN, thus resulting in a problem that if the SN and the MN support different radio access technologies, the SN may not be able to read the secondary cell group failure information encoded according to the Radio Resource Control (RRC) of the MN, so that the SN cannot determine the cause of the SCG failure, and accordingly corresponding optimization cannot be made. In the method of the present disclosure, if the SN and the MN support different radio access technologies, the MN does not directly include the secondary cell group failure information (such as SCGFailureInformation or SCGFailureInformationEUTRA or SCGFailureNR) received from the UE, into the interface message between base stations to be transmitted to the SN, and instead, the MN puts the SCG failure information in the RRC of the radio access technology supported by the secondary base station contained in the secondary cell group failure information of the MN RRC message, into the message between base stations and transmits the same to the SN. In this way, even if the SN does not support the RRC of the radio access technology of the MN, the SN can obtain necessary information from the interface message between base stations, so as to detect a type of the failure and make corresponding optimization.

For example, if the MN is a gNB supporting the NR access technology, the SN which leads to the failure is an ng-eNB supporting the E-UTRA, when the MN receives the SCG failure information in the NR RRC from the UE, in the prior art, the MN includes the SCG failure information in the NR RRC into the message between base stations to be transmitted to the SN. In the method of the present disclosure, the MN includes the SCG failure information in LTE RRC format contained in the SCG failure information in NR RRC, into message between base stations to be transmitted to the SN.

If the MN only determines which node caused the failure, the source SN, the target SN or the candidate SN determines the type of failure, for example, the too early PSCell change, too late PSCell change, or trigger of the PSCell change to the wrong PSCell, after receiving the message from the MN. The specific method for determining is the same as that in step 303, and will not be described here.

For the CPC procedure, the source SN can further determine whether the failure is caused by unreasonable configuration of CPC candidate cells or by unreasonable configuration of CPC execution condition(s). If the suitable cell is not in the CPC candidate cells configured to the UE, the failure is caused by the unreasonable configuration of CPC candidate cells. If the suitable cell is not in the list of the CPC candidate cells recommended by the source SN that triggers the PSCell change, the problem is caused by the source SN that triggers the PSCell change. If the suitable cell is in the list of the CPC candidate cells recommended by the source SN that triggers the PSCell change, but not in the list of the candidate PSCells selected by the target SN or the candidate target SN, the failure is caused by the target SN or the candidate target SN. For the trigger of the PSCell change to the wrong PSCell, the source SN can further determine whether the failure is caused by the unreasonable configuration of the candidate cell.

The source SN can also determine whether the failure is caused by an estimated arrival possibility which is set improperly. For example, the estimated arrival probability transmitted by the source SN to the candidate target SN via the MN is set too low, while the suitable cell is in the candidate SNs, and thus the source SN is the node that leads to the failure.

The node (source SN, target SN or candidate target SN, or MN) which leads to the failure also make reasonable optimizations for the PSCell change or the CPC.

So far, the second method for supporting self-configuration and self-optimization proposed in the present disclosure has been described, and such method can support robustness of the PSCell change in the mobility procedure, especially the robustness in the PSCell change between the different RATs, and thus correctly identify the causes of the failure, so as to make reasonable optimization, reduce occurrence of failure, ensure service continuity, and reduce labor cost of an operator.

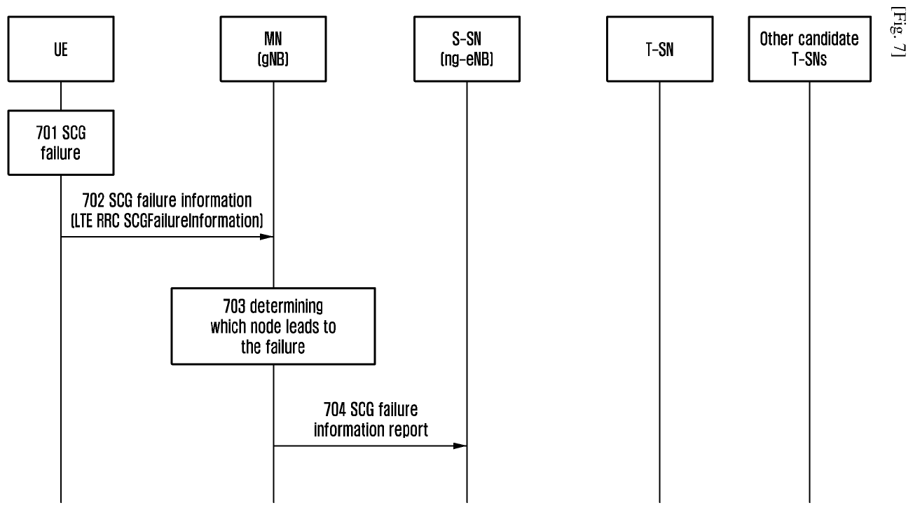

FIG. 7 illustrates a first embodiment of the second method supporting self-configuration and self-optimization according to the present disclosure. In the embodiment, the MN is a gNB and the source SN can be an ng-eNB. The method comprises the following steps:

At Step 701, a SCG failure occurs. The SCG failure may be a failure of the target PSCell access to the target SN perform by a UE or a failure occurring in the CPC execution to the target PSCell or a failure occurring after a successful PSCell change. The UE stores information related to the failure.

For example, there is a recent PSCell change, the source PSCell for the recent PSCell change and the MN support different radio access technologies, and the MN supports the NR radio access technology and the source SN supports the E-UTRA radio access technology. The UE stores the LTE RRC SCG failure information and NR RRC SCG failure information. The information related to the failure is the information on the secondary cell group failure described in step 301, which is not repeated here.

At step 702, the UE transmits the SCG failure information to the MN. The SCG failure information can be the SCGFailureInformation or SCGFailureInformationEUTRA. The SCG failure information includes the information as described at step 301, and further includes SCGFailureInformation in the format of LTE RRC. Information contained in the SCGFailureInformation in the format of LTE RRC is the same as that described in step 301, which will not be repeated here.

At step 703, the MN determines which node causes the failure. The MN uses the same determining method as that at step 302, which will not be described here. The MN can further determine the type of failure, and the specific determining method is the same as that at step 302, which will not be repeated here.

If the failure is caused by the MN, the procedure ends, and the subsequent steps do not need to be performed.

For the problem caused by the source SN, step 704 is performed.

At step 704, the MN transmits SCG failure information report message to the source SN. The message includes the SCGFailureInformation in the LTE RRC. The SCGFailureInformation in the LTE RRC is included in the SCGFailureInformation or SCGFailureInformationEUTRA in the NR RRC received from the UE.

The message may also include the information transmitted by the MN to the source SN at step 303, which will not be repeated here. The message transmitted by the MN to the source SN may be an existing SCG failure information report or other messages. If the type of the failure is determined by the source SN, the source SN uses the same determining method as that described at step 303.

So far, the first embodiment of the second method for supporting self-configuration and self-optimization proposed in the present disclosure has been described, and such a method can support robustness of the PSCell change in the mobility procedure, especially the robustness in the PSCell change between the different RATs, and thus correctly identify the cause of the failure, so as to make reasonable optimization, reduce occurrence of failure, ensure service continuity, and reduce labor cost of an operators.

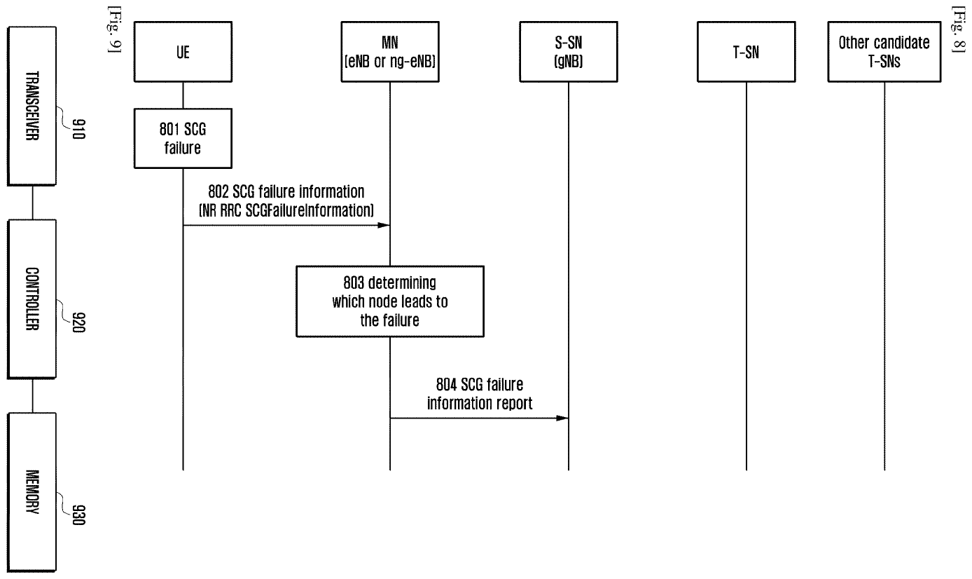

FIG. 8 illustrates a second embodiment of the second method supporting self-configuration and self-optimization according to the present disclosure. In this embodiment, the MN is an eNB or an ng-eNB, and if the MN is an eNB, the source SN is a gNB (en-gNB) as the SN in the EN-DC. If the MN is an ng-eNB, the source SN can be a gNB. The method comprises the following steps:

At step 801, a SCG failure occurs. The SCG failure may be a failure when the UE accesses to the target PSCell of the target SN or a failure occurring in the CPC execution to the target PSCell or a failure occurring after a successful PSCell change. The UE stores information related to the failure. The information related to the failure is the information on the secondary cell group failure described at step 301, which will not be repeated here.

For example, there is a recent PSCell change, the source PSCell for the recent PSCell change and the MN support different radio access technologies, and the MN supports the LTE radio access technology and the source SN supports the NR radio access technology. The UE stores the LTE RRC SCG failure information and NR RRC SCG failure information. The information related to the failure is the information on the secondary cell group failure described in step 301, which is not repeated here.

At step 802, the UE transmits the SCG failure information to the MN. The SCG failure information may be the secondary cell group failure information (SCGFailureInformation) or the secondary cell group failure information NR (SCGFailureInformationNR). If the PSCell where the failure occurs is an NR cell, the SCG failure information is the SCGFailureInformationNR. If the PSCell where the failure occurs is an E-UTRA cell, the SCG failure information is the SCGFailureInformation. The SCG failure information includes the information as described at step 301, and further includes the SCGFailureInformation in the format of NR RRC. The information contained in the SCGFailureInformation in the format of NR RRC is the same as that described in step 301, which will not be repeated here

The UE may transmit the SCG failure information to the MN through an existing SCG failure information message or other RRC messages.

At step 803, the MN determines which node causes the failure. The MN uses the same determining method as that at step 302, which will not be described here. The MN can further determine a type of failure, and the specific decision method is the same as that at step 302, which will not be repeated here.

If the failure is caused by the MN, the procedure ends, and the subsequent steps do not need to be performed.

For the problem caused by the source SN, step 804 is performed.

At step 804, the MN transmits SCG failure information report message to the source SN. The message includes the SCGFailureInformation in the NR RRC. The SCGFailureInformation in the NR RRC is included in the SCGFailureInformation or the SCGFailureInformationNR in the LTE RRC received from the UE.

The message may also include the information transmitted by the MN to the source SN at step 303, which will not be repeated here. The message transmitted by the MN to the source SN may be an existing SCG failure information report or other messages. If the type of the failure is determined by the source SN, the source SN uses the same determining method as that described at step 303.

So far, the second embodiment of the second method for supporting self-configuration and self-optimization proposed in the present disclosure has been described, and such method can support robustness of the PSCell change in the mobility procedure, especially the robustness in the PSCell change between the different RATs, and thus correctly identify the cause of the failure, so as to make reasonable optimization, reduce occurrence of the failure, ensure service continuity, and reduce labor cost of an operator.

To sum up, the method for supporting self-configuration and self-optimization according to the present disclosure is described. The method of the disclosure can support the robustness of the PSCell change in the mobility procedure, especially the robustness of the PSCell change between different RATs, and thus correctly identify the causes of the failure, so as to make reasonable optimization, reduce the occurrence of failure, ensure service continuity, and reduce the labor cost of operators.

FIG. 9 is a block diagram of a network node in a network according to the present disclosure.

The network node in the network can be used to implement the MN, the SN, the S-SN, the T-SN, other candidate T-SNs, etc. in the present disclosure. With reference to FIG. 9, the network node according to the present disclosure includes a transceiver 910, a controller 920 and a memory 930. The transceiver 910, the controller 920 and the memory 930 are configured to perform operations of the methods and/or embodiments of the present disclosure. Although the transceiver 910, the controller 920 and the memory 930 are illustrated as separate entities, they can be implemented as a single entity, such as a single chip. The transceiver 910, the controller 920 and the memory 930 may be electrically connected or coupled to each other. Transceiver 910 can transmit signals to other network nodes and receive signals from other network entities, such as UE, MN, SN, S-SN, T-SN, other candidate T-SNs or core network nodes. The controller 920 may include one or more processing units, and may control network nodes to perform operations and/or functions according to one of the above embodiments. The memory 930 may store instructions for implementing the operations and/or functions of one of the above embodiments.

Those skilled in the art will understand that the above illustrative embodiments are described herein and are not intended to be limiting. It should be understood that any two or more of the embodiments disclosed herein can be combined in any combination. In addition, other embodiments can be utilized and other changes can be made without departing from the spirit and scope of the subject matter presented herein. It will be readily understood that aspects of the present disclosure as generally described herein and illustrated in the drawings can be arranged, replaced, combined, separated and designed in various different configurations, all of which are contemplated herein.

Those skilled in the art will understand that various illustrative logical blocks, modules, circuits, and steps described in the present application can be implemented as hardware, software, or combinations of both. To clearly illustrate such inter-changeability between hardware and software, various illustrative components, blocks, modules, circuits, and steps are generally described above in the form of their functional sets. Whether such a function set is implemented as hardware or software depends on the specific application and the design constraints imposed on the overall system. Technicians can implement the described set of functions in different ways for each specific application, but such design decisions should not be interpreted as causing a departure from the scope of the present application.

The various illustrative logic blocks, modules, and circuits described in the present application can be implemented with a general purpose processor, a Digital Signal Processor (DSP), an application specific integrated circuit (ASIC), a Field Programmable Gate Array (FPGA) or other programmable logic devices, discrete gate or transistor logic, discrete hardware components, or any combination thereof designed to perform the functions described herein. The general-purpose processor may be a microprocessor, but in an alternative, the processor may be any conventional processor, controller, microcontroller, or state machine. The processor can also be implemented as a combination of computing devices, such as a combination of a DSP and a microprocessor, a plurality of microprocessors, one or more microprocessors cooperating with a DSP core, or any other such configuration.

The steps of the method or algorithm described in the present application can be directly embodied in hardware, in a software module executed by a processor, or in a combination of the two. The software modules may reside in RAM memory, flash memory, ROM memory, EPROM memory, EEPROM memory, registers, hard disks, removable disks, or any other form of storage media known in the art. An exemplary storage medium is coupled to the processor so that the processor can read and write information from/to the storage medium. In an alternative, the storage medium may be integrated into the processor. The processor and the storage medium may reside in the ASIC. The ASIC may reside in the user terminal. In an alternative, the processor and the storage medium may reside as discrete components in the user terminal.

In one or more exemplary designs, the functions can be implemented in hardware, software, firmware, or any combination thereof. If implemented in software, each function can be stored on or transferred by a computer-readable medium as one or more instructions or codes. Computer readable media include both computer storage media and communication media, the latter including any media that facilitates the transfer of computer programs from one place to another. Storage media can be any available media that can be accessed by general-purpose or special-purpose computers.

The above descriptions are only exemplary implementations of the present application, and are not intended to limit the protection scope of the present application, which is determined by the appended claims.

1-14. (canceled)

15. A method performed by a first network node in a communication system, comprising:
receiving, from a terminal, a secondary cell group (SCG) failure information message including at least one of an identity of a failed primary SCG cell (PSCell), an identity of a source PSCell or time information on the SCG failure;
determining a second network node associated with the SCG failure, based on the SCG failure information message; and
transmitting, to the second network node, a SCG failure information report message including a SCG failure report container including the SCG failure information message.

16. The method of claim 15, further comprising:
in case that the SCG failure caused by other nodes is determined by the second network node, receiving, from the second network node, a message indicating that the SCG failure is caused by other nodes;
transmitting, to a third network node, the SCG failure information report message.

17. The method of claim 15, wherein, the SCG failure information report message further includes the at least one of the identity of the failed PSCell, the identity of the source PSCell or the time information on the SCG failure.

18. The method of claim 15, wherein, the first network node and the second network node support different radio access technologies (RATs).

19. The method of claim 15, wherein, the first network node is an evolved Node B (eNB), and
wherein the second network node is a next generation Node B (gNB).

20. The method of claim 15, wherein the time information on the SCG failure indicates a time elapsed from the terminal receiving a radio resource control RRC reconfiguration message for a PSCell change to an occurrence of the SCG failure.

21. A method performed by a second network node in a communication system, comprising:
receiving, from a first network node, a secondary cell group (SCG) failure information report message, the SCG failure information report message including a SCG failure report container including a SCG failure information message; and
determining which node is associated with the SCG failure, based on the SCG failure information report message,
wherein the SCG failure information message includes the at least one of an identity of a failed primary SCG cell (PSCell), an identity of a source PSCell or time information on the SCG failure.

22. The method of claim 21, further comprising:
determining, based on the SCG failure information report message, that the SCG failure is caused by other nodes; and
transmitting, to the first network node, a message indicating that the SCG failure is caused by other nodes.

23. The method of claim 21, further comprising:
determining, based on the SCG failure information report message, that the SCG failure is caused by the second network node; and
performing self-optimization based on a type of the SCG failure.

24. The method of claim 21, wherein, the first network node and the second network node support different radio access technologies (RATs).

25. A first network node in a communication system, comprising:
a memory;
a transceiver; and
a processor configured to:
receive, from a terminal via the transceiver, a secondary cell group (SCG) failure information message including at least one of an identity of a failed primary SCG cell (PSCell), an identity of a source PSCell or time information on the SCG failure;
determine a second network node associated with the SCG failure, based on the SCG failure information message; and
transmit, to the second network node via the transceiver, a SCG failure information report message including a SCG failure report container including the SCG failure information message.

26. The first network node of claim 25, wherein, the processor is further configured to:
in case that the SCG failure caused by other nodes is determined by the second network node, receive, from the second network node via the transceiver, a message indicating that the SCG failure is caused by other nodes;
transmit, to a third network node via the transceiver, the SCG failure information report message.

27. The first network node of claim 25, wherein, the SCG failure information report message further includes the at least one of the identity of the failed PSCell, the identity of the source PSCell or the time information on the SCG failure.

28. The first network node of claim 25, wherein, the first network node and the second network node support different radio access technologies (RATs).

29. The first network node of claim 25, wherein, the first network node is an evolved Node B (eNB), and
wherein the second network node is a next generation Node B (gNB).

30. The first network node of claim 25, wherein, the time information on the SCG failure indicates a time elapsed from the terminal receiving a radio resource control RRC reconfiguration message for a PSCell change to an occurrence of the SCG failure.

31. A second network node in a communication system, comprising:
a memory;
a transceiver; and
a processor configured to:
receive, from a first network node via the transceiver, a secondary cell group (SCG) failure information report message, the SCG failure information report message including a SCG failure report container including a SCG failure information message; and
determine which node is associated with the SCG failure, based on the SCG failure information report message,
wherein the SCG failure information message includes the at least one of an identity of a failed primary SCG cell (PSCell), an identity of a source PSCell or time information on the SCG failure.

32. The second network node of claim 31, wherein the processor is further configured to:
determine, based on the SCG failure information report message, that the SCG failure is caused by other nodes; and
transmit, to the first network node via the transceiver, a message indicating that the SCG failure is caused by other nodes.

33. The second network node of claim 31, wherein the processor is further configured to:
determine, based on the SCG failure information report message, that the SCG failure is caused by the second network node; and
perform self-optimization based on a type of the SCG failure.

34. The second network node of claim 31, wherein, the first network node and the second network node support different radio access technologies (RATs).
